(19) United States
(12) Patent Application Publication
(10) Pub. No.: US 2009/0139441 A1
(43) Pub. Date: Jun. 4, 2009

(54) WRAP AROUND BANNER

(76) Inventor: Neil Barone, Rumson, NJ (US)

Correspondence Address: Connolly Bove Lodge & Hutz LLP, P.O. Box 2207, Wilmington, DE, 19899-2207, US

(21) Appl. No.: 11/950,064

(22) Filed: Dec. 4, 2007

(51) Int. Cl. G09F 17/00

(52) U.S. Cl. 116/173

(57) ABSTRACT

A wrap around banner is in the form of a flexible body having an exposed display on at least its front side. Adjustable attachment structure is located on the back side of the body extending inwardly from a first end of the body. Complementary adjustable attachment structure is located on the front side of the body extending inwardly from an opposite second end. The banner is wrapped around an object until its ends are superimposed and the banner is firmly mounted in place by engagement of the attachment structure and complementary attachment structure.

### BACKGROUND OF THE INVENTION

Various banners are used for different purposes. Such banners may, for example, be in the form of flags or may convey messages or may be simply of a decorative nature. A conventional manner of mounting a banner is through the use of a pole, such as a flag pole which would then be mounted in a suitable bracket secured to a wall, a column or a tree or any other suitable support. In conventional mounting techniques it is necessary to use various tools to initially install a flag pole bracket to the support. Such procedures are inconvenient and are avoided by various individuals. In addition, with conventional practices, by having the banner exposed to the elements, such as by blowing in the wind, the banner may become damaged over time or its message may not be readily visible.

### SUMMARY OF THE INVENTION

An object of this invention is to provide a banner which could be easily installed in a secure manner without the need for special tools.

A further object of this invention is to mount a banner with minimum possibility of damage to the banner.

A still further object of this invention is to provide such a banner which could be adjustably mounted to various types of support objects by being wrapped around the object.

In accordance with this invention the banner has adjustable attachment structure on its back side extending inwardly from one end of the banner. Complementary adjustable attachment structure is mounted on the front side of the banner extending inwardly from an opposite end. To be displayed, the banner is wrapped about itself with the front side overlying the backside and with the adjustment structure being detachably secured together so that the banner could be adjustably wrapped around the object and held firmly in place in such a manner that the front side is readily visible.

The attachment structure is preferably in the form of elongated strips and more preferably of the known hook/loop fastening structure. A border may be provided around the exposed display portion of the banner, such as a flag, with the attachment strips located at the border.

### THE DRAWINGS

FIG. 1 is a front elevational view of a tree showing a banner wrapped around the trunk and another banner wrapped around one of its limbs in accordance with this invention; and

FIG. 2 is a front elevational view of one of the banners shown in FIG. 1.

### DETAILED DESCRIPTION

The present invention relates to a banner decoration that wraps around and secures to an object or support such as a tree, column, lamppost, telephone pole, or any other object either indoors or outdoors. The banner could be made in any suitable known manner using known techniques such as being made from such flexible material as polyester, nylon, canvas, vinyl, plastic, etc. The banner itself could be of various styles and colors.

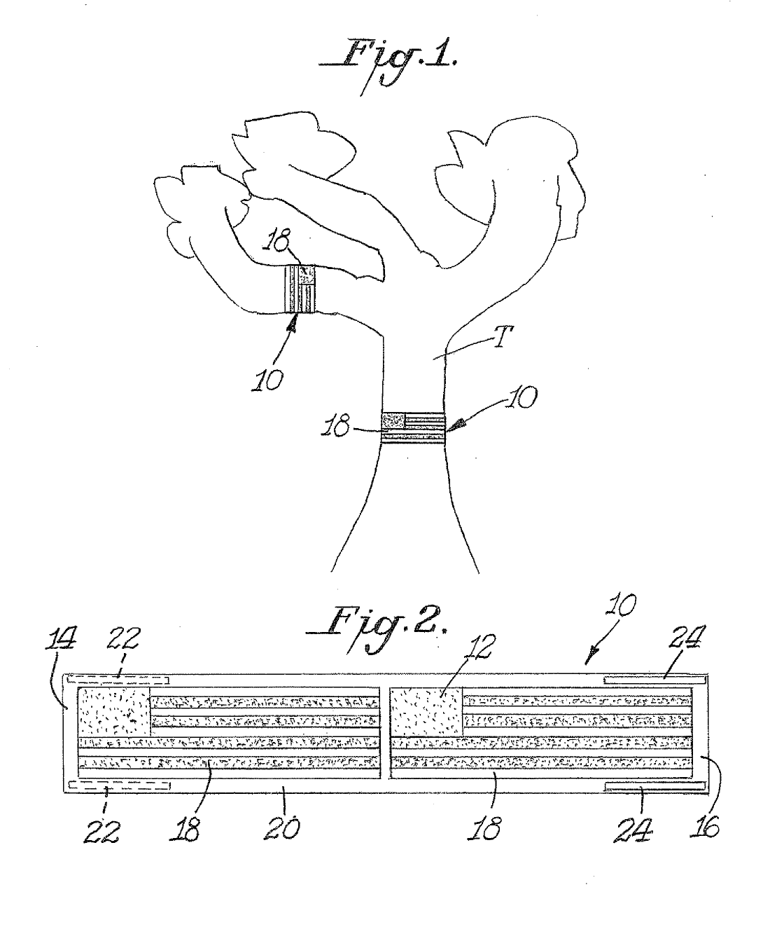

FIG. 1 illustrates a plurality of banners 10 in accordance with this invention. As shown in FIG. 1, each banner 10 is wrapped around a different portion of a tree T, such as around the trunk or around a limb. It is to be understood that the illustration of a tree is merely for exemplary purposes. The wrap around banner 10 could be conveniently mounted to virtually any object which is preferably of elongated form and could have a circular, rectangular, square, oblong or any other cross-sectional shape that would permit the banner to be wrapped around the object. Examples of such support objects include columns that might be in front of a house or building, lamp posts or telephone poles or any other such object.

As illustrated in FIG. 2 banner 10 is made of a flexible body 12 having a front side and a back side and having a first end 14 and a second opposite end 16. The banner 10 shown in FIG. 2 is illustrated as being a flag, such as an American flag, which would be of generally rectangular shape. The invention, however, could be broadly practiced with other shapes such as a pennant having a triangular shape, as later discussed.

The front side of the banner would have an exposed display 18 which in the illustrated form is a flag. The display may, of course, extend completely through the body and also be visible on the backside as with conventional flags. Where the banner is intended to convey some message, the display might be only on the front side. Examples of banners include various types of flags, peace signs, Support Our Troops, Conquer Cancer, Christmas, Halloween, Thanksgiving, various holidays, Happy Birthday, licensed sports logos, etc. The display may include information material, such as For Sale, The Party Is Here, business information, etc. The exposed display might occupy substantially the entire front side of body 12 or the exposed display could be a repetitive display. FIG. 2, for example, illustrates a set of two linearly aligned flags. If desired, more than two repetitive displays can be used including multiple displays providing different display information. The selection of the number of displays would depend on the intended end result. For example, when wrapped around a large object, such as a thick square column, it might be desirable to have a separate display for each of the sides of the column. The multiple or repetitive displays would be desirable for wrapping around oversized objects, such as a large tree, a thick column or a barrel.

A key feature of the banner 10 is the use of adjustable attachment structure so that the banner may be tightly wrapped around the object. FIG. 2 illustrates a border 20 extending completely around the periphery of the front side and preferably also the backside of body 12. The border serves as a convenient location for the attachment structure so that the attachment structure is not superimposed over and thus obstruct the exposed display. Preferably, the attachment structure is in the form of elongated strips 22 which are located on the backside of body 12 and extend inwardly from the first end 14. The strips 22 begin at the corner of the border 20 and extend inwardly a sufficient amount to provide the desired degree of adjustability. Complementary adjustable attachment structure 24 is provided on the front side of body 12 and extend inwardly from the second end 16 in the same manner as adjustable attachment structure 22. Any suitable form of attachment structure could be used within the concepts of this invention such as snaps, buttons, strings, ropes, wires, etc. In the preferred practice of this invention, however, the elongated strips which comprise the attachment structure 22,24 are hook and loop tapes, (e.g. VELCRO) as is known. Thus, for example, one of the attachment structures could be in the form of hooks which engage the loops on the other attachment structure.

The banner 10 shown in FIG. 2 thus lends itself to be easily attached to an object such as tree T by placing the backside of body 12 against the tree (such as the trunk or limb) and then wrapping body 12 around that portion of the tree until the free end of the banner is superimposed over and in surface to surface contact with the first end that is initially against the tree. When so mounted the adjustable attachment structure 22 and complementary adjustable attachment structure 24 are disposed against each other and interlock to securely mount the banner 10 to the object, such as tree T. If it should be desired to remove banner 10, the outer portion of banner 10 which is superimposed against the portion in contact with the tree is pulled away from the portion in contact with the tree to unlock the attachment structures and thereby detach the banner from the object.

In the preferred practice of this invention, the banner 10 is made of rectangular shape having four perpendicular corners which join a top and a bottom and the two opposite ends 14,16. The term rectangular shape is intended to also include a square shape which likewise would have such perpendicular corners and sides. The invention, however, could be practiced with other shapes, such as an oval shape or a triangular or trapezoidal shape. With such other shapes the attachment structure and complementary attachment structure would have to be placed so that they would contact each other when the banner is wrapped around the object and upon itself. A rectangular shape is preferred since it minimizes any unsecured portions of the banner.

Banner 10 could be made of any suitable size such as 12 inches high and 48 inches long. The border 20 could, for example, be a 1 inch white border thereby being of sufficient dimension to accommodate the hook tape and loop tapes and the border would completely surround the display 18 such as each flag shown in FIG. 2.

As is apparent from FIG. 1 banner 10 could be mounted on both horizontal and vertical objects since the adjustable attachment structure would tightly secure the banner into place regardless of orientation. If desired, the effective length of the banner could be increased by attaching a plurality of banners together end to end. For example, the attachment structure at one end of one banner may be attached to the attachment structure at the end of an adjacent banner to couple the banners together. This is particularly convenient using hook tape and loop tape. If the combined length of two banners is insufficient any number of banners could be mounted together end to end.

Banner 10 thus provides the ability to be mounted in multiple locations both indoors and outdoors without the use of hardware, tools, screws, nails, ropes, poles, etc. which are commonly required when hanging banners or flags. The banners can be easily installed and easily removed and installed elsewhere. In addition, the banner would completely surround the item or object to which it is attached without having any loose ends flapping in the wind. This would preserve the integrity of the fabric since it would not be subject to wind shear that would eventually result in tears and tatters that frequently occur to conventional banners and flags.

What is claimed is:

1. A wrap around banner having flexible body with a front side and a back side and having a first end and a second end remote from said first end, said front side having an exposed display, adjustable attachment structure on said back side extending inwardly from said first end, complementary adjustable attachment structure on said front side extending inwardly from said second end, and said attachment structure and said complementary attachment structure being located to be detachably secured together when said body is bent upon itself to form a closed loop with said first end against and outwardly of said second end and said front side against and outwardly of said back side at the location where said first end and said second end are against each other whereby said banner may be mounted around an object.

2. The banner of claim 1 wherein said attachment structure and said complementary attachment structure are in the form of a plurality of elongated strips.

3. The banner of claim 2 wherein said body includes a top edge and a bottom edge, and said strips being located at both said top edge and said bottom edge in addition to said first end and said second end.

4. The banner of claim 3 wherein said attachment structure and said complementary attachment structure are in the form of loop tapes and hook tapes.

5. The banner of claim 3 wherein a border is located around said exposed display, and said strips being located in said border.

6. The banner of claim 5 wherein said exposed display is in the form of multiple exposed displays in line with each other.

7. The banner of claim 6 wherein said multiple exposed displays are repetitive displays which are the same as each other.

8. The banner of claim 7 wherein said body is of rectangular shape.

9. The banner of claim a wherein said exposed display is a flag.

10. The banner of claim 9 wherein said body is made of a fabric, and said attachment structure and said complementary attachment structure being in the form of hook/loop structure.

11. The banner of claim 1 wherein a plurality of said banners are mounted together end to end by securing said attachment structure of one banner to said complementary attachment structure of an adjacent banner.

12. A method of mounting a banner to an object comprising providing a banner which has adjustable attachment structure on its back side and complementary adjustable attachment structure on its front side, mounting one end of the banner against the object, and wrapping the banner around the object until the opposite end of the banner is superimposed over the one end to engage the attachment structure and complementary attachment structure with each other and thereby firmly secure the banner to the object.

13. The method of claim 12 wherein the banner is a flag and the attachment structure and complementary structure are in the form of strips of hook tape and loop tape, and locating the strips in a border around the flag.
